(19) United States
(12) Patent Application Publication
(10) Pub. No.: US 2010/0264284 A1
(43) Pub. Date: Oct. 21, 2010

(54) IN-CAR MOUNTING STRUCTURE FOR PORTABLE AUTOMOTIVE INSTRUMENT

(76) Inventor: CHIN TE LAI, Taipei City (TW)

Correspondence Address: RABIN & Berdo, PC, 1101 14TH STREET, NW, SUITE 500, WASHINGTON, DC, 20005, US

(21) Appl. No.: 12/426,464

(22) Filed: Apr. 20, 2009

(51) Int. Cl. F16B 47/00; A47B 96/06; H01R 33/00

(52) U.S. Cl. 248/205.5; 248/220.21; 248/222.14; 439/34

(57) ABSTRACT

An in-car mounting structure for portable automotive instrument includes a positioning case installed in a predetermined space behind a dashboard of a car and a portable device holder. The positioning case is internally divided by a partition plate into a first and a second receiving space. A movable gate is pivotally turnably connected to an open end of the first receiving space, and the portable device holder is assembled to an outer face of the movable gate for holding a portable electronic device thereto. A power receptacle is provided in the first receiving space and connected to an in-car power supply, and includes a jack corresponding to a plug of the portable electronic device. With the in-car mounting structure for portable automotive instrument, the portable electronic device can be mounted in the car without blocking the driver's sight during driving or spoiling an esthetic interior appearance of the car.

### FIELD OF THE INVENTION

The present invention relates to an in-car mounting structure for portable automotive instrument, and more particularly to a mounting structure that is installed in a predetermined space behind the dashboard of a car for a portable electronic device, such as a GPS navigator, a mobile phone or a personal digital assistant (PDA) to detachably mount thereto without blocking the driver's sight during driving.

### BACKGROUND OF THE INVENTION

Following the development in the economic society and the popularization of cars, there are more and more people who drive in business trips or leisure activities. In the case of an unfamiliar destination, it might take the driver a lot of time to locate the right paths to the destination. Therefore, the driver would usually refer to a map, either a paper map or an electronic map, before starting the trip, or prepare a paper map on the car for use when necessary, so as to avoid getting lost on the way to the destination.

Checking the map in advance or on the way to the destination is troublesome and takes a lot of time, and there are chances guideposts on the roads are unclear or not matching with the map to cause confusions to the driver. To solve this problem, navigators equipped with the global positioning system (GPS) are developed and available in the market. The navigators combining satellite and wireless communication techniques can automatically choose the shortest possible driving path leading to the destination, and shows navigating information on a display. The navigator system is also provided with a speech system to remind the driver of the correct driving direction.

As can be seen from FIG. 1, the GPS navigator for use on a car is generally a portable navigator 10, which is practical for use because it can guide a user to the right path, and can be conveniently dismounted from the car for connecting to a computer for updating road-related information. A mounting structure 11 is usually supplied along with the portable navigator 10 when a user buys the latter, so that the portable navigator 10 can be fixed to a central area of the windshield 12 of the car via the mounting structure 11.

Please refer to FIG. 2. To ensure the driver's, the pedestrians' and other drivers' safety, it is absolutely necessary for the driver to clearly view the road condition surrounding the car via the windshield. However, when the portable navigator 10 is fixed to the central area of the windshield 12 via the conventional mounting structure 11, the navigator 10 will inevitably block the driver's sight to the right front side of the car via the windshield 12 to form a potential risk of endangering pedestrians or other cars and therefore bring confusions to the driver. When the portable navigator 10 has a relatively large mass volume, the mounting structure 11 will also have an increased size to stably hold the portable navigator 10 thereto. As a result, the area on the windshield being blocked by the portable navigator 10 and the mounting structure 11 is also expanded to largely increase the danger in driving. When driving in nighttime with the portable navigator 10 in use, light emitted from the display of the portable navigator 10 will produce a visually blind spot within the viewing range of the windshield 12 to blur the driver's sight during driving and cause danger, accordingly.

Moreover, when the portable navigator 10 is low in power, a charging cable 13 must be connected to and between the portable navigator 10 and an in-car power supply 14 to charge the battery of the portable navigator 10. This is of course inconvenient for the driver to do so, and the extra length of the charging cable 13 disorderly distributed in the car will also spoil the esthetic interior appearance of the car.

### SUMMARY OF THE INVENTION

A primary object of the present invention is to provide an in-car mounting structure for portable automotive instrument that includes a positioning case installed in a predetermined space behind a dashboard of a car and a portable device holder assembled to a front side of the positioning case for a portable electronic device to detachably mount thereto, so that the portable electronic device is located at a position in the car without blocking the driver's sight during driving or producing a blind spot on the windshield when being used in nighttime during driving, allowing the driver to drive safely.

Another object of the present invention is to provide an in-car mounting structure for portable automotive instrument that includes a positioning case, which is internally provided with a power receptacle connected to an in-car power supply, so that power can be directly supplied from the in-car power supply to a portable electronic device mounted to the in-car mounting structure, allowing the portable electronic device to have higher utilization efficiency.

A further object of the present invention is to provide an in-car mounting structure for portable automotive instrument that includes a positioning case defining an inner receiving space for accommodating extra power cord of a portable electronic device mounted to the in-car mounting structure, and a movable gate assembled to an open end of the positioning case, so as to maintain an esthetic interior appearance in the car.

A still further object of the present invention is to provide an in-car mounting structure for portable automotive instrument that includes a positioning case capable of receiving an in-car electronic device therein, so that the mounting structure can provide additional functions and is more practical and convenient for use.

To achieve the above and other objects, the in-car mounting structure for portable automotive instrument according to a preferred embodiment of the present invention is installed in a predetermined space behind a dashboard of a car for a portable electronic device, such as a navigator, a mobile phone, a PDA, or an MP3 player to assemble to an open end of the predetermined space. The in-car mounting structure for portable automotive instrument includes a positioning case configured corresponding to the size of the predetermined space for installing in the predetermined space behind the dashboard. The positioning case is internally divided by a partition plate into a first and a second receiving space. A movable gate is assembled to an end of the first receiving space adjacent to the open end of the predetermined space, and a first through hole is formed at another end of the first receiving space opposite to the open end. An end of the second receiving space adjacent to the open end is an open inlet, and a second through hole is formed at another end of the second receiving space opposite to the open end. And, a portable device holder is assembled to an outer face of the movable gate for detachably holding the portable electronic device thereto.

The positioning case is provided on two opposite lateral walls thereof with a fixing structure for fixing the positioning case to the predetermined space. The movable gate and the partition plate are provided at a joining position between them with a locking structure and a through passage. The locking structure is a fastening mechanism and can be any one of screws, a mortise joint, and a latch.

The in-car mounting structure for portable automotive instrument further includes a power receptacle located in the first receiving space and connected to an in-car power supply via the first through hole; and the power receptacle is provided with a jack configured corresponding to a plug of the portable electronic device. In an operable embodiment, the jack is a cigarette lighter socket applicable to a plug on a cable for general navigators.

In the second receiving space, an in-car electronic device can be further installed and connected to the in-car power supply via the second through hole. In an operable embodiment, the in-car electronic device is a multimedia player, which includes a control module, an input module and a movable front panel arranged at the open end of the predetermined space, and a processing module and an output module arranged inside the second receiving space. The processing module is connected to the input module and the control module, and the output module is connected to the processing module. In an operable embodiment, the input module includes a USB port, an optical disk drive, and a card reader. In another operable embodiment, the in-car electronic device is a driving speed sensor for reminding the driver to drive at a safety speed.

In an embodiment, the portable device holder is a circular disk screwed to the movable gate, and the circular disk has an outward smooth positioning plane face, to which the portable electronic device can be attached via vacuum suction. In another embodiment, the movable gate is provided at a central position on the outer face thereof with a positioning recess, and the portable device holder includes a base configured corresponding to the positioning recess and a circular disk formed at a distal end of the base to provide an outward smooth positioning plane face.

The portable device holder can be otherwise a suction unit having a front suction face, a locking element centered on a rear side of the suction face for engaging with a screw element, and a threaded structure formed on a back portion of the suction unit behind the suction face for the screw element to thread therethrough. In another preferred embodiment, the portable device holder is a suction unit having a neck portion outward extended from the movable gate and a suction face provided on a distal end of the neck portion; the neck portion is internally provided with a lever, an end of which is connected to a central area of the suction face.

Alternatively, the portable device holder can be a spherical locating member having a connecting rod portion, which has a first end assembled to the movable gate, a diametrically expanded circular flange portion formed around a predetermined position on the connecting rod portion, and a spherical head portion formed at an opposite second end of the connecting rod portion to cooperate with a compression structure. In another preferred embodiment, the portable device holder is a compression unit having a connecting rod portion assembled at an end to the movable gate, a circular disk portion formed around another end of the connecting rod portion for pressing against the outer face of the movable gate, and an annular wall portion axially extended from the circular disk portion opposite to the connecting rod portion to provide a receiving space therein. The annular wall portion is externally provided with a screw-thread structure, and the compression unit further includes a hollow sleeve for mounting around the annular wall portion, and the hollow sleeve is internally provided with a screw-thread structure for meshing with the external screw-thread structure on the annular wall portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional mounting structure for fixing a GPS navigator in a car;

FIG. 2 shows the GPS navigator fixed in a car using the conventional mounting structure of FIG. 1 is located at a middle area of a windshield of the car;

FIG. 3 shows the location in a car at where an in-car mounting structure for portable automotive instrument according to the present invention is installed;

FIG. 4 is a perspective view of the in-car mounting structure for portable automotive instrument according to a first embodiment of the present invention;

FIG. 5 is a sectioned top view of FIG. 4 showing an internal structure of the first embodiment of the present invention;

FIG. 6 shows a movable gate for the present invention is pivotally turned to an open position;

FIG. 7 is an exploded perspective view of an in-car mounting structure for portable automotive instrument according to a second embodiment of the present invention having a differently configured portable device holder;

FIG. 8 is an assembled perspective view of an in-car mounting structure for portable automotive instrument according to a third embodiment of the present invention;

FIG. 9 is a fragmentary sectioned top view of FIG. 8 showing the structure of a portable device holder for the third embodiment;

FIG. 10 is similar to FIG. 9 with the portable device holder being manipulated to produce a suction space thereat;

FIG. 11 is an assembled perspective view of an in-car mounting structure for portable automotive instrument according to a fourth embodiment of the present invention;

FIG. 12 is an exploded perspective view of an in-car mounting structure for portable automotive instrument according to a fifth embodiment of the present invention;

FIG. 13 is an exploded perspective view of an in-car mounting structure for portable automotive instrument according to a sixth embodiment of the present invention;

FIG. 14 shows the in-car mounting structure for portable automotive instrument of the present invention with an in-car electronic device mounted in a positioning case thereof;

FIG. 15 shows a front panel outside the in-car electronic device of FIG. 14 is pivotally turned to an open position;

FIG. 16 is a phantom view showing the manner of connecting a portable electronic device to the in-car mounting structure of the present invention; and

FIG. 17 shows the present invention and the portable electronic device mounted thereto are located within and in front of a dashboard of the car, respectively.

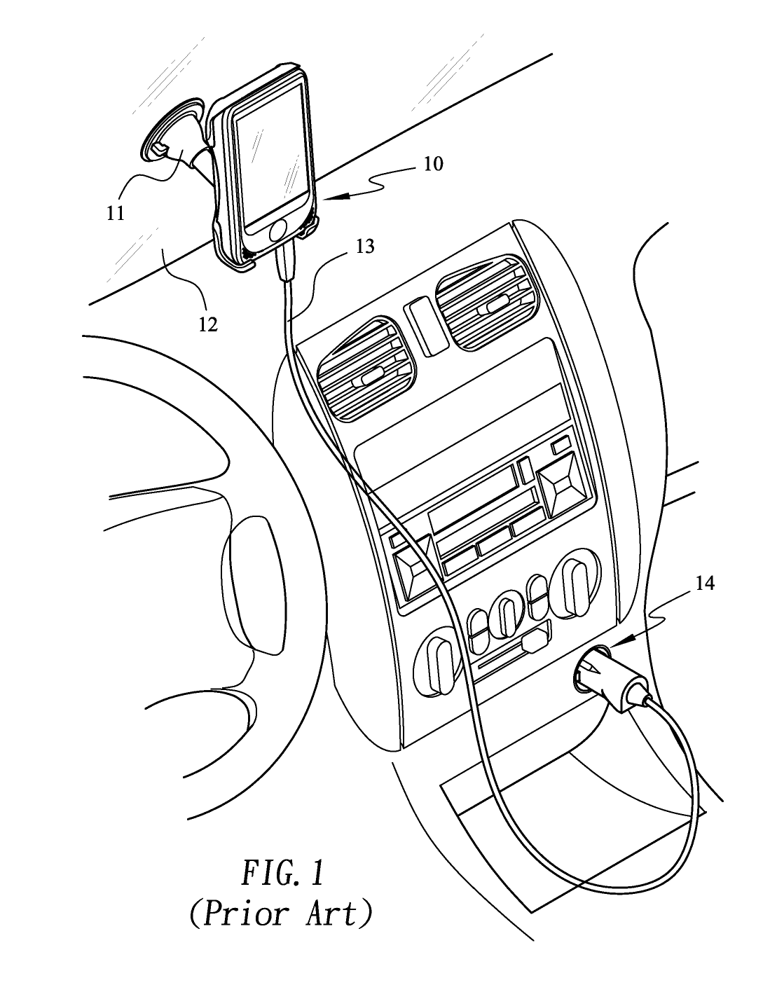

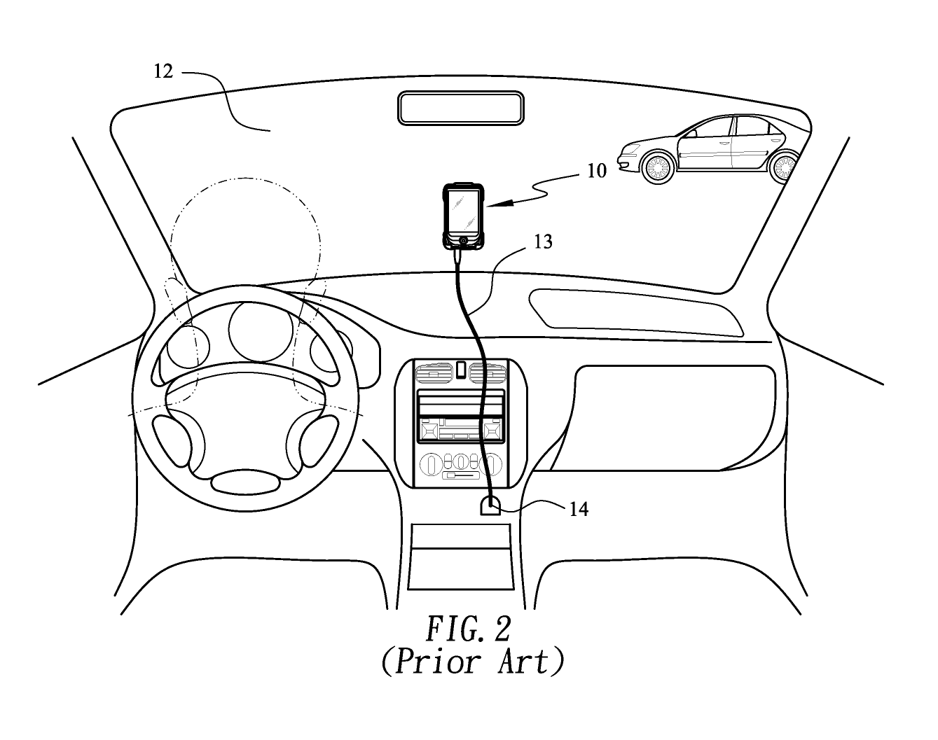

### DETAILED DESCRIPTION OF THE PREFERRED EMBODIMENTS

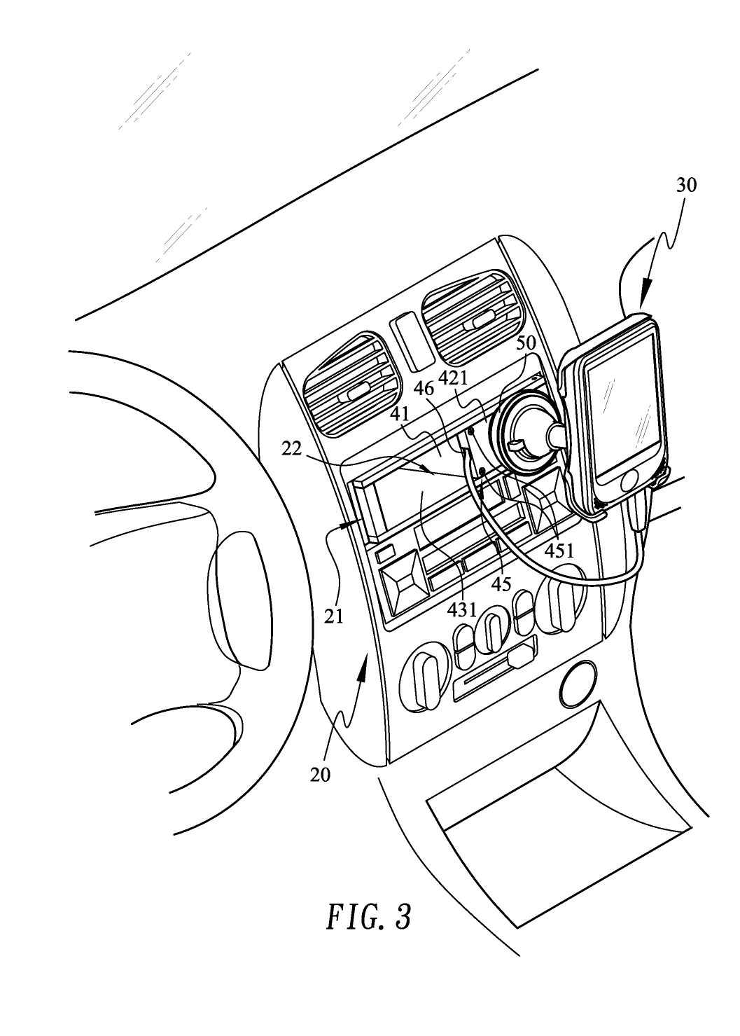

Please refer to FIG. 3. An in-car mounting structure for portable automotive instrument according to the present invention is installed in a predetermined space 21 behind a dashboard 20 of a car and connected to an in-car power supply, and a portable electronic device 30 can be mounted to an open end 22 of the predetermined space 21. In the illustrated embodiment, the portable electronic device 30 is a GPS navigator. However, it is understood the portable electronic device 30 is not limited to the GPS navigator, but can be other types of electronic devices, such as a mobile phone, a personal digital assistant (PDA), an MP3 player, etc.

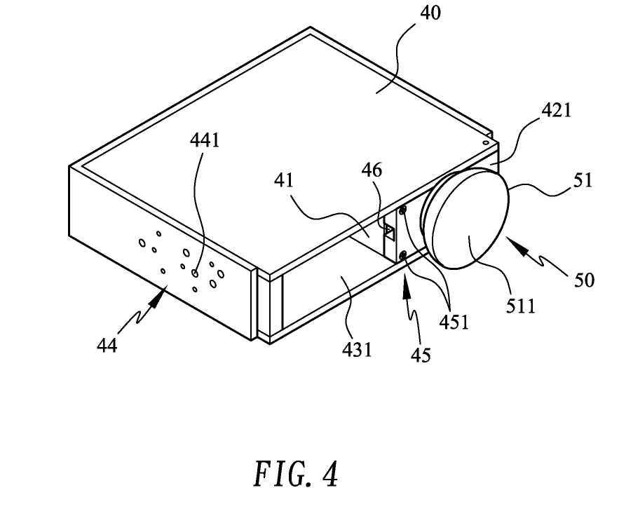

Please refer to FIG. 4. The in-car mounting structure for portable automotive instrument according to the present invention includes a positioning case 40 configured for correspondingly installed in the predetermined space 21, and a portable device holder 50.

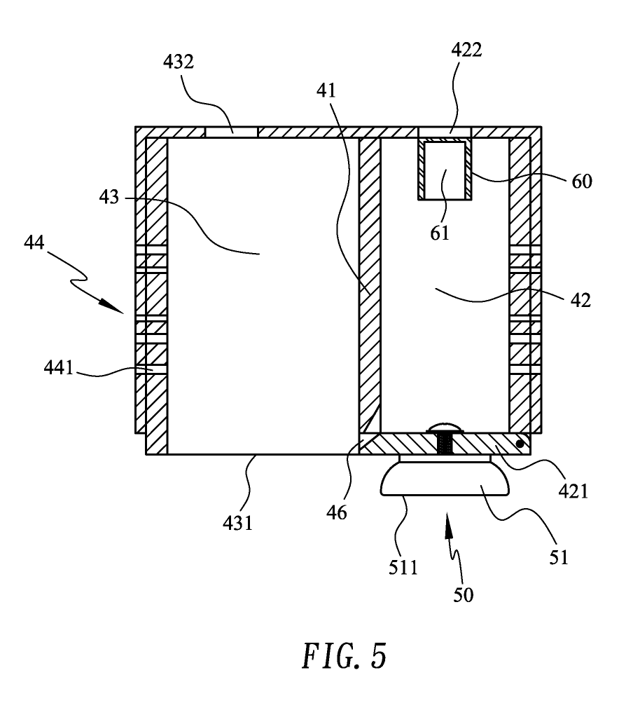

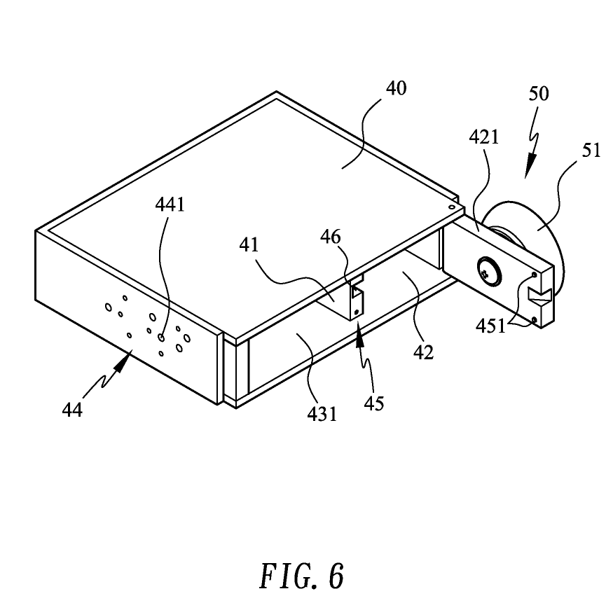

As can be seen from FIGS. 5 and 6, the positioning case 40 is internally divided by a partition plate 41 into a first receiving space 42 for accommodating a power cord of the portable electronic device 30 and a second receiving space 43 for holding other portable articles. A fixing structure 44 is provided on two opposite lateral walls of the positioning case 40 for fixing the positioning case 40 to the predetermined space 21. According to an operable embodiment, the fixing structure 44 can include a plurality of screw holes 441, so that the positioning case 40 can be fixed in the predetermined space 21 using screws.

A movable gate 421 is pivotally turnably connected to one end of the first receiving space 42 adjacent to the open end 22, and a first through hole 422 is formed on another end of the first receiving space 42 opposite to the open end 22. An end of the second receiving space 43 adjacent to the open end 22 is an open inlet 431, and a second through hole 432 is formed on another end of the second receiving space 43 opposite to the open end 22. A locking structure 45 is provided at a joining position between the movable gate 421 and the partition plate 41 to releasably lock the movable gate 421 to the partition plate 41. And, a through passage 46 is also formed on and between the movable gate 421 and the partition plate 41 for extending the power cord of the portable electronic device 30 therethrough into the first receiving space 42. In the illustrated embodiment, the locking structure 45 can be any one of screws 451, a mortise joint (not shown), and a latch (not shown).

The portable device holder 50 is arranged on the movable gate 421 outside the first receiving space 42. In the illustrated embodiment, the portable device holder 50 is a circular disk 51 screwed to the movable gate 42. The circular disk 51 has an outward smooth positioning plane face 511, to which the portable electronic device 30 can be attached via vacuum suction.

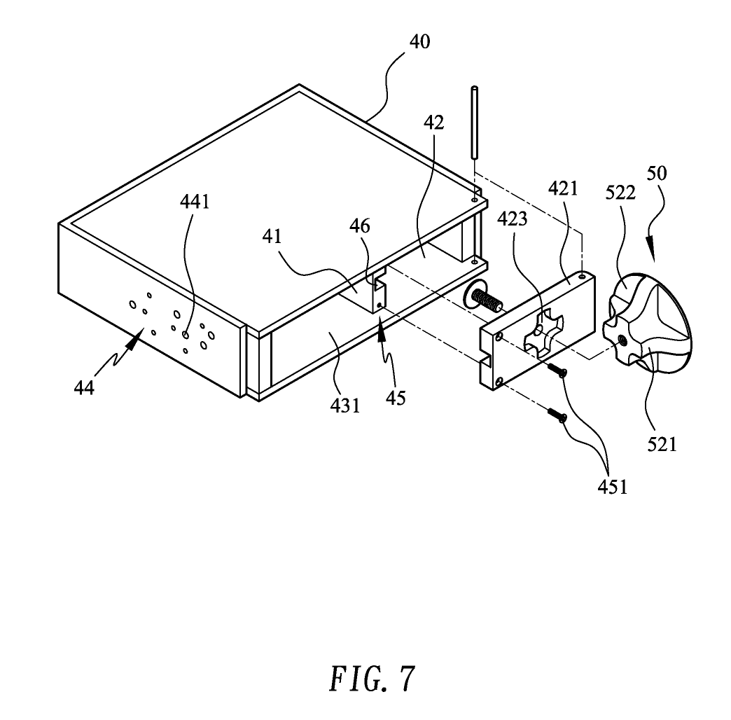

FIG. 7 is an exploded perspective view of an in-car mounting structure for portable automotive instrument according to a second embodiment of the present invention.

The second embodiment is generally structurally similar to the first embodiment except for the movable gate 421 and the portable device holder 50. In the second embodiment, the movable gate 421 is provided at a central position on an outer face thereof with a substantially cross-shaped positioning recess 423, and the portable device holder 50 includes a substantially cross-shaped base 521 configured corresponding to the cross-shaped positioning recess 423 and a circular disk 522 formed at a distal end of the base 521. The circular disk 522 provides an outward smooth positioning plane face, to which the portable electronic device 30 can be attached via vacuum suction.

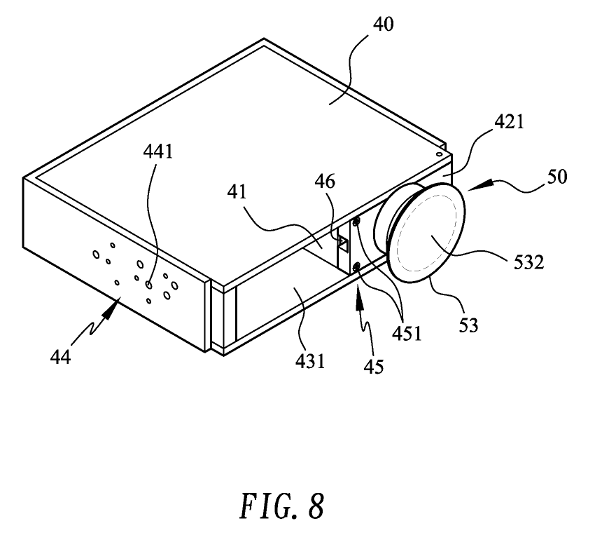

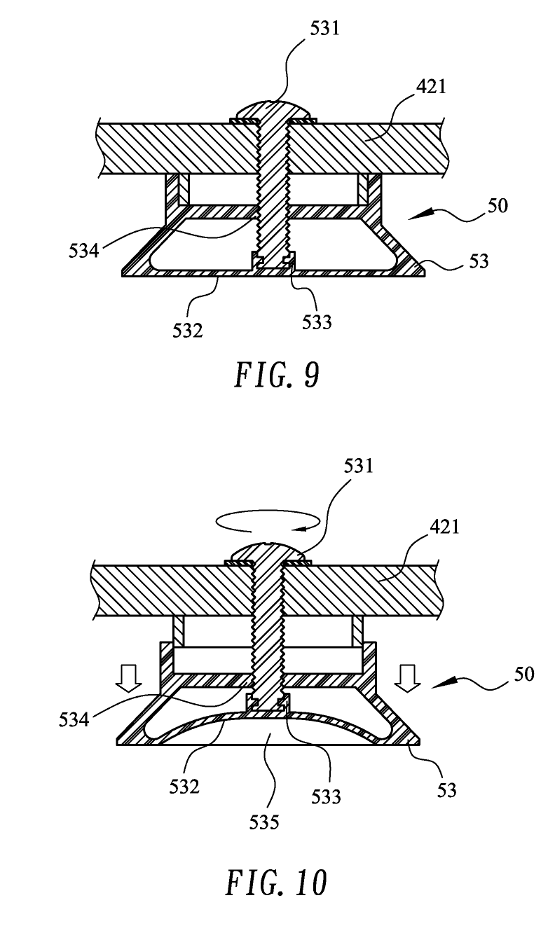

FIGS. 8 to 10 show an in-car mounting structure for portable automotive instrument according to a third embodiment of the present invention. The third embodiment is generally structurally similar to the first embodiment except for the portable device holder 50. In the third embodiment, the portable device holder 50 is a suction unit 53 externally assembled to the movable gate 421 via a screw element 531. The suction unit 53 includes a front suction face 532, a locking element 533 centered on a rear side of the suction face 532 for engaging with the screw element 531, and a threaded structure 534 formed on a back portion of suction unit 53 behind the suction face 532. The screw element 531 is screwed through the threaded structure 534 to engage with the locking element 533.

To use the suction unit 53, first dispose the portable electronic device 30 on the suction face 532 and then turn the suction unit 53, so that the threaded structure 534 and the suction face 532 are caused to move outward relative to the movable gate 421. Since the locking element 533 is engaged with the screw element 531, a central area of the suction face 532 remains unmoved while a peripheral area surrounding the central area is pushed outward. Therefore, a suction space 535 with negative pressure is produced at the suction face 532 to suck the portable electronic device 30 (not shown in FIGS. 8 to 10) to the portable device holder 50 via vacuum suction.

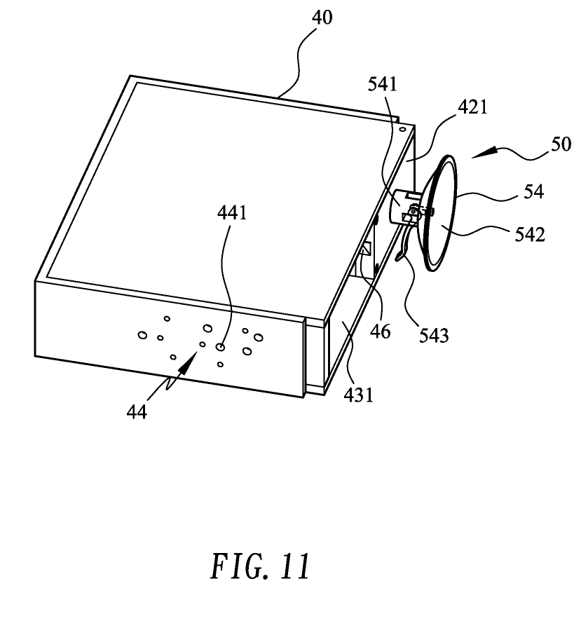

FIG. 11 shows an in-car mounting structure for portable automotive instrument according to a fourth embodiment of the present invention. The fourth embodiment is generally structurally similar to the first embodiment except for the portable device holder 50. In the fourth embodiment, the portable device holder 50 is a suction unit 54 externally assembled to the movable gate 421. The suction unit 54 includes a neck portion 541 outward extended from the movable gate 421 and a suction face 542 provided on a distal end of the neck portion 541. The neck portion 541 is internally provided with a lever 543, a first end of which is connected to a central area of the suction face 542. By applying a force on a second end of the lever 543 to pull the same outward, the first end of the lever 543 will bring the central area of the suction face 542 to move inward and thereby produce a suction space at the suction face 542 to suck the portable electronic device 30 (not shown in FIG. 11) to the portable device holder 50 via vacuum suction.

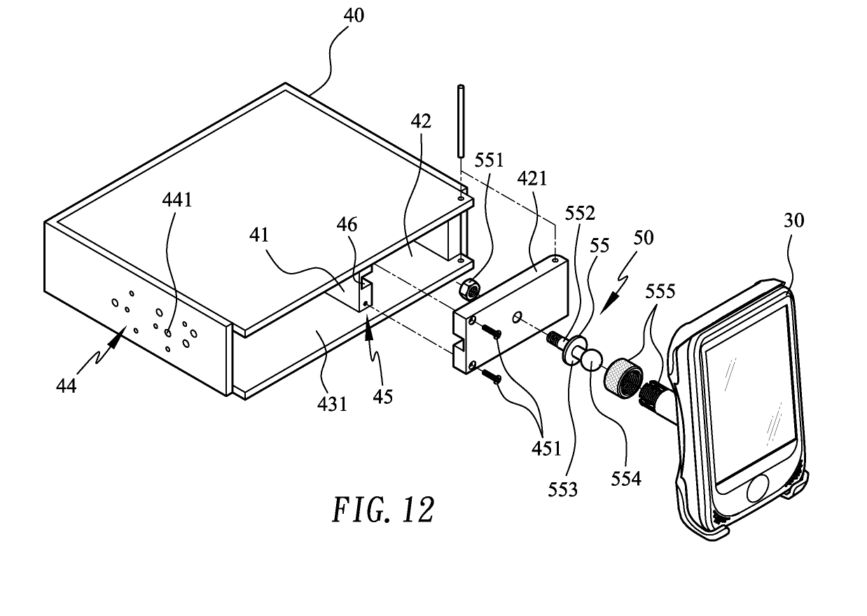

Please refer to FIG. 12 that is an exploded perspective view of an in-car mounting structure for portable automotive instrument according to a fifth embodiment of the present invention. The fifth embodiment is generally structurally similar to the first embodiment except for the portable device holder 50. In the fifth embodiment, the portable device holder 50 includes a spherical locating member 55, which is fixed to an outer face of the movable gate 421 through engagement with a nut 551. The spherical locating member 55 includes a connecting rod portion 552, which has an externally threaded first end extended through the movable gate 421 to engage with the nut 551; a diametrically expanded circular flange portion 553 formed around a predetermined position on the connecting rod portion 522 for pressing against the outer face of the movable gate 421; and a spherical head portion 554 formed at an opposite second end of the connecting rod portion. The spherical head portion 554 cooperates with a compression structure 555 to hold the portable device holder 50 to the movable gate 421.

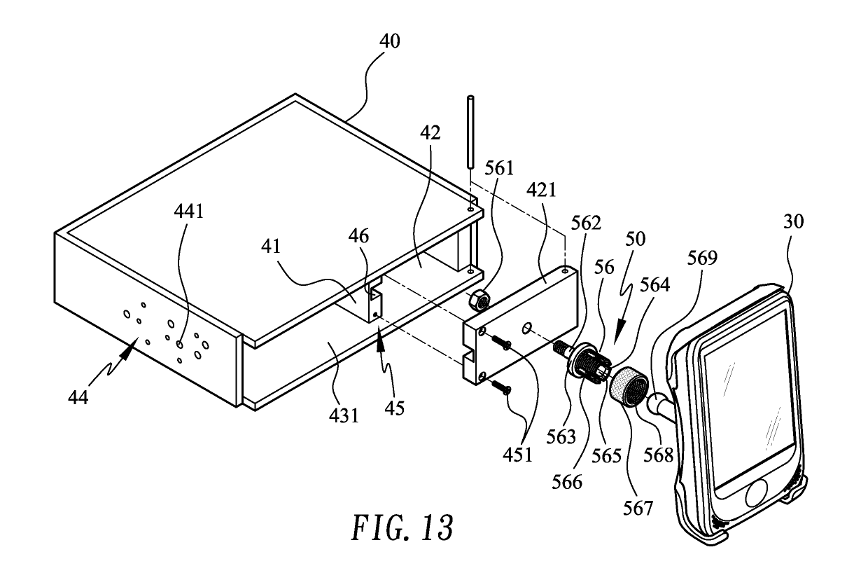

Please refer to FIG. 13 that is an exploded perspective view of an in-car mounting structure for portable automotive instrument according to a sixth embodiment of the present invention. The sixth embodiment is generally structurally similar to the fifth embodiment except for the portable device holder 50. In the sixth embodiment, the portable device holder 50 is a compression unit 56 being fixed to the outer face of the movable gate 421 through engagement with a nut 561. The compression unit 56 includes a partially externally threaded connecting rod portion 562 for engaging with the nut 561; a circular disk portion 563 formed around a distal end of the connecting rod portion 562 for pressing against the outer face of the movable gate 421; and an annular wall portion 564 axially extended from the circular disk portion 563 opposite to the connecting rod portion 562 to provide a receiving space 565 therein. The annular wall portion 564 is provided with an external screw-thread structure 566. The compression unit 56 further includes a hollow sleeve 567 for mounting around the annular wall portion 564. The hollow sleeve 567 is provided with an internal screw-thread structure 568 for meshing with the external screw-thread structure 566 on the annular wall portion 564.

The compression unit 56 usually cooperates with a spherical structure 569 provided on a back of a holding bracket. By disposing the spherical structure 569 in the receiving space 565 defined by the annular wall portion 564 and then screwing the hollow sleeve 567 around the annular wall portion 564, the spherical structure 569 can be firmly held in the annular wall portion 564 of the compression unit 56.

Please refer back to FIG. 5. The in-car mounting structure for portable automotive instrument further includes a power receptacle 60, which is connected to an in-car power supply. The power receptacle 60 is located in the first receiving space 42 and connected to the in-car power supply via the first through hole 422. The portable electronic device 30 can be plugged into the power receptacle 60 to obtain power supply. In a preferred embodiment, the power receptacle 60 has a jack 61 being configured corresponding to the power cord of the portable electronic device 30. Alternatively, in another operable embodiment, the jack 61 is a cigarette lighter socket, which is applicable to the plugs on the power cords of most kinds of general portable electronic devices 30.

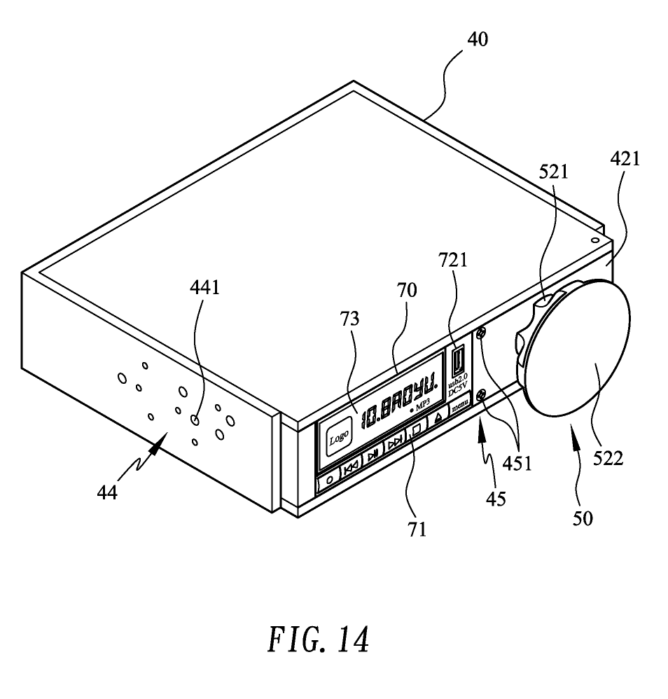

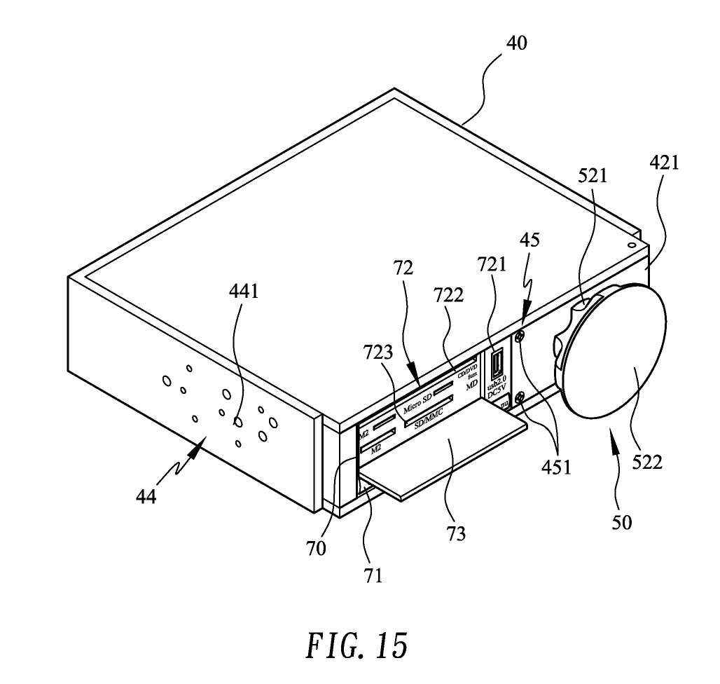

Please refer to FIGS. 14 and 15. In the second receiving space 43, an in-car electronic device can be installed and connected to the in-car power supply via the second through hole 432. In the illustrated embodiment, the in-car electronic device is a multimedia player 70, which includes a control module 71, an input module 72, and a movable front panel 73 arranged at the open end 22 of the positioning case 40, a processing module arranged inside the second receiving space 43 to connect to the input module and the control module 71, and an output module (not shown) connected to the processing module (not shown).

As can be seen from FIGS. 14 and 15, the control module 71 is a panel or a keypad arranged at the open end 22. In another operable embodiment, the control module 71 is a receiver unit for receiving a remote control signal, and can work with a remote control unit (not shown).

In a preferred embodiment, the input module 72 includes a USB port 721, an optical disk drive 722, and a card reader 723. The input module 72 can be used with various kinds of electronic devices having a memory or a storage unit, including but not limited to a compact disk (CD), a USB mass storage device, a memory card, an external hard disk, and a mobile phone. That is, the input module 72 can be any reader for reading electronic data.

The movable front panel 73 is mounted to an outer side of the input module 72, and has a pivoting member (not shown) to allow vertical turning of the front panel 73 about the pivoting member. When it is desired to use the input module 72, simply pivotally turn the front panel 73 from a closed position to an open position. And, when the use of the input module 72 is completed, the front panel 73 can be pivotally turned to the closed position again to cover the outer side of the input module 72, giving the multimedia player 70 an integral and esthetic appearance.

The processing module includes a decoder for converting the data read by the input module 72 into a desired file format, and transmitting the data of the converted file to the output module, which is connected to in-car speakers or stereos.

In an operable embodiment, the in-car electronic device can be a speed sensor (not shown) for reminding a driver to drive at an allowable safety speed.

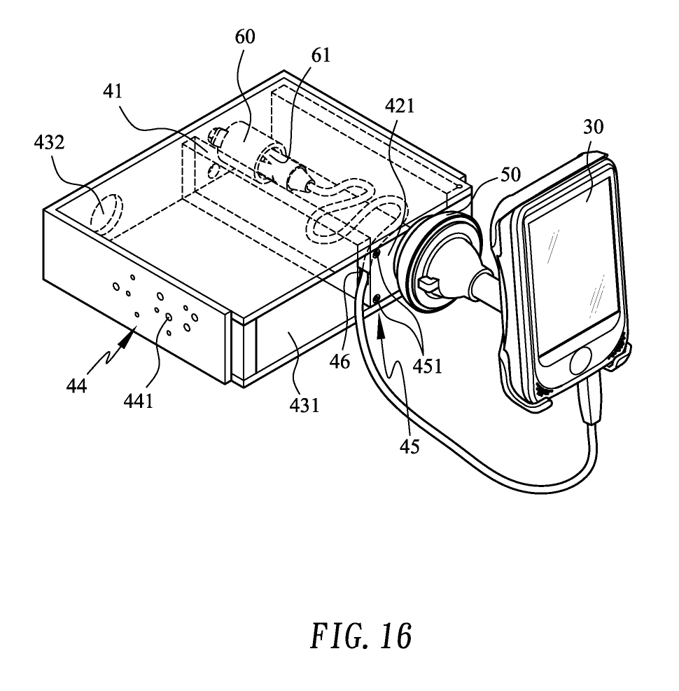

Please refer to FIGS. 3, 6 and 16 at the same time. The in-car mounting structure for portable automotive instrument of the present invention is installed in the predetermined space 21 behind the dashboard of the car. The predetermined space 21 is generally a space below cooling air outlets and having specified dimensions. The power receptacle 60 is connected to the in-car power supply. When it is desired to mount the portable electronic device for use, first pivotally turn the movable gate 421 outside the first receiving space 42 from the closed position to the open position, and then connect the power cord of the portable electronic device 30 to the jack 61 on the power receptacle 60 in the first receiving space 42. The extra length of the power cord is organized and stored in the first receiving space 42. The movable gate 421 is then pivotally turned to the closed position again with a necessary length of the power cord extending through the through passage 46 to an outer side of the movable gate 421. Finally, mount and secure the portable electronic device 30 to the portable device holder 50, and plug the power cord into the portable electronic device 30.

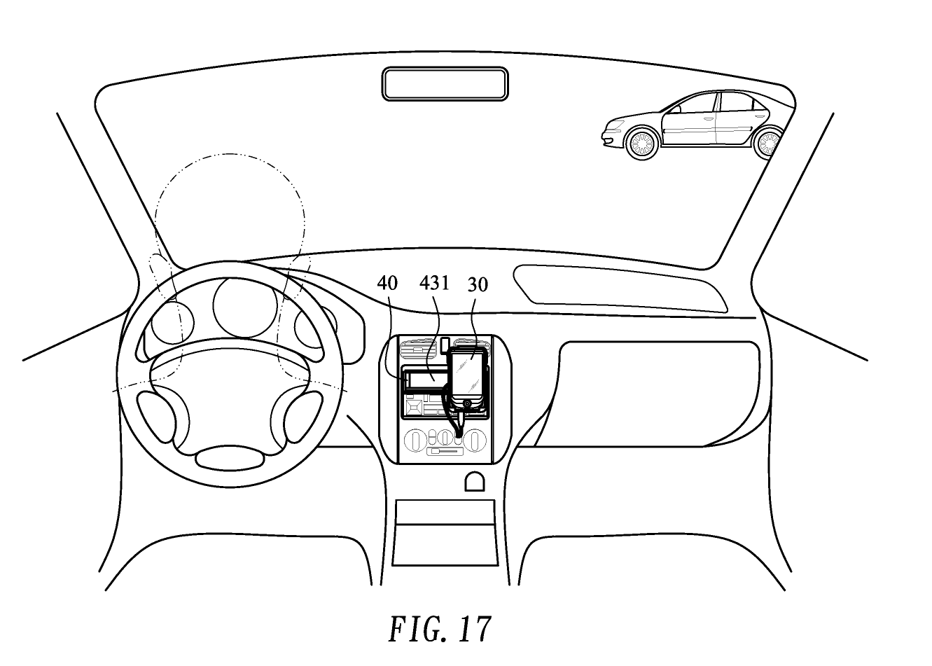

Please refer to FIG. 17. Unlike the conventional way of mounting the GPS navigator 10 at a middle area of the windshield of a car, which will block the driver's sight to the right front side of the car to cause danger in driving, the in-car mounting structure for portable automotive instrument of the present invention after having been fully installed is located in the predetermined space 21 behind the dashboard 20 without blocking the driver's sight to the right front side of the car, allowing the driver to clearly see any other cars or pedestrians passing by the right front side of the car. In addition, when the driver drives in nighttime with the GPS navigator mounted to the middle area of the windshield in the conventional way, light emitted from the screen of the navigator 10 will produce a visual blind spot within the range of the windshield, preventing the driver from clearly viewing the road condition. Therefore, as compared to the conventional way of mounting a portable electronic device to the windshield, the in-car mounting structure for portable automotive instrument of the present invention is safer for use because the portable electronic device mounted in the car via the mounting structure would not block the driver's sight through the windshield and would not produce any blind spot even the driver drives in nighttime.

In conclusion, the in-car mounting structure for portable automotive instrument of the present invention includes a positioning case installed in a predetermined space behind the dashboard of the car and a portable device holder for holding the portable electronic device thereto. Therefore, the portable electronic device mounted in the car via the in-car mounting structure of the present invention does not block the windshield or produce any blind spot during driving or in nighttime, allowing the driver to drive safely. Meanwhile, the positioning case is internally provided with a power receptacle connected to the in-car power supply and the portable electronic device, so that power can be directly supplied from the in-car power supply to the portable electronic device to ensure high utilization efficiency thereof. Moreover, since one of the partitioned receiving spaces in the positioning case can be conveniently used to organize and store extra length of the power cord of the portable electronic device, and the movable gate can be easily pivotally turned between a closed and an open position, the in-car mounting structure with the portable electronic device mounted thereto can still have an esthetic appearance.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An in-car mounting structure for portable automotive instrument, being installed in a predetermined space behind a dashboard of a car to allow a portable electronic device to mount to an open end of the predetermined space; the in-car mounting structure for portable automotive instrument comprising:
a positioning case being configured corresponding to the size of the predetermined space behind the dashboard for fitly installed therein; the positioning case being internally divided by a partition plate into a first receiving space and a second receiving space; a movable gate being pivotally turnably connected to an end of the first receiving space adjacent to the open end of the predetermined space, and a first through hole being formed on another end of the first receiving space opposite to the open end; an end of the second receiving space adjacent to the open end of the predetermined space being an open inlet, and a second through hole being formed on another end of the second receiving space opposite to the open end; and
a portable device holder being fixedly connected to the movable gate to locate outside the first receiving space for holding the portable electronic device thereto.

2. The in-car mounting structure for portable automotive instrument as claimed in claim 1, wherein the positioning case is provided on two opposite lateral walls thereof with a fixing structure for installing the positioning case to the predetermined space.

3. The in-car mounting structure for portable automotive instrument as claimed in claim 1, wherein the movable gate and the partition plate are provided at a joining position between them with a locking structure and a through passage.

4. The in-car mounting structure for portable automotive instrument as claimed in claim 3, wherein the locking structure is a fastening mechanism selected from the group consisting of screws, a mortise joint, and a latch.

5. The in-car mounting structure for portable automotive instrument as claimed in claim 1, further comprising a power receptacle located in the first receiving space and connected to an in-car power supply via the first through hole; and the power receptacle being provided with a jack, which is configured corresponding to a plug of the portable electronic device.

6. The in-car mounting structure for portable automotive instrument as claimed in claim 5, wherein the jack is a cigarette lighter socket.

7. The in-car mounting structure for portable automotive instrument as claimed in claim 1, wherein the second receiving space has an in-car electronic device installed therein, and the in-car electronic device is connected to an in-car power supply via the second through hole.

8. The in-car mounting structure for portable automotive instrument as claimed in claim 7, wherein the in-car electronic device is a multimedia player, which includes a control module, an input module and a movable front panel arranged at the open end of the predetermined space, and a processing module and an output module arranged inside the second receiving space; the processing module being connected to the input module and the control module, and the output module being connected to the processing module.

9. The in-car mounting structure for portable automotive instrument as claimed in claim 8, wherein the input module includes a USB port, an optical disk drive, and a card reader.

10. The in-car mounting structure for portable automotive instrument as claimed in claim 7, wherein the in-car electronic device is a driving speed sensor.

11. The in-car mounting structure for portable automotive instrument as claimed in claim 1, wherein the portable device holder is a circular disk screwed to the movable gate, and the circular disk having an outward smooth positioning plane face, to which the portable electronic device can be attached via vacuum suction.

12. The in-car mounting structure for portable automotive instrument as claimed in claim 1, wherein the movable gate is provided at a central position on an outer face thereof with a substantially positioning recess, and the portable device holder includes a base configured corresponding to the positioning recess and a circular disk formed at a distal end of the base; and the circular disk providing an outward smooth positioning plane face.

13. The in-car mounting structure for portable automotive instrument as claimed in claim 1, wherein the portable device holder is a suction unit having a front suction face, a locking element being centered on a rear side of the suction face for engaging with a screw element, and a threaded structure being formed on a back portion of the suction unit behind the suction face, so that the screw element is screwed through the threaded structure to engage with the locking element.

14. The in-car mounting structure for portable automotive instrument as claimed in claim 1, wherein the portable device holder is a suction unit having a neck portion outward extended from the movable gate and a suction face provided on a distal end of the neck portion; the neck portion being internally provided with a lever, and an end of the lever being connected to a central area of the suction face.

15. The in-car mounting structure for portable automotive instrument as claimed in claim 1, wherein the portable device holder is a spherical locating member having a connecting rod portion, which has a first end assembled to the movable gate, a diametrically expanded circular flange portion formed around a predetermined position on the connecting rod portion, and a spherical head portion formed at an opposite second end of the connecting rod portion to cooperate with a compression structure.

16. The in-car mounting structure for portable automotive instrument as claimed in claim 1, wherein the portable device holder is a compression unit having a connecting rod portion assembled at an end to the movable gate, a circular disk portion formed around another end of the connecting rod portion for pressing against an outer side of the movable gate, and an annular wall portion axially extended from the circular disk portion opposite to the connecting rod portion to provide a receiving space therein; the annular wall portion being externally provided with a screw-thread structure, and the compression unit further including a hollow sleeve for mounting around the annular wall portion, and the hollow sleeve being internally provided with a screw-thread structure for meshing with the external screw-thread structure on the annular wall portion.
